(19) United States
(12) Patent Application Publication
(10) Pub. No.: US 2026/0291299 A1
(43) Pub. Date: Sep. 24, 2026

(54) STATOR

(71) Applicant: DENSO CORPORATION, Kariya-city (JP)

(72) Inventors: Ryo MITANI, Kariya-city (JP); Naoto NATSUME, Kariya-city (JP); Masayuki ECHIZEN, Kariya-city (JP)

(73) Assignee: DENSO CORPORATION, Kariya-city (JP)

(21) Appl. No.: 19/687,342

(22) Filed: May 26, 2026

Related U.S. Application Data
(63) Continuation of application No. PCT/JP2024/031758, filed on Sep. 4, 2024.

(30) Foreign Application Priority Data
Nov. 24, 2023 (JP) 2023-199407

(51) Int. Cl. H02K 1/14; H02K 3/34; H02K 3/52

(52) U.S. Cl. CPC H02K 1/148; H02K 3/345; H02K 3/522

(57) ABSTRACT

A stator includes: a stator core having a plurality of tooth parts extending in a radial fashion; insulators formed of resin and mounted to the stator core; and coil winding parts each of which is wound on a corresponding one of the tooth parts of the stator core via a corresponding one of the insulators. Moreover, the stator core has mounting surfaces on each of which a corresponding one of the insulators is mounted. In each of the mounting surfaces, there is formed a groove that is located on an opposite side of the corresponding insulator to the corresponding coil winding part. A gas layer is formed between the stator core and the corresponding insulator by the groove.

### CROSS-REFERENCE TO RELATED APPLICATIONS

The present application is a continuation application of International Application No. PCT/JP2024/031758 filed on Sep. 4, 2024, which is based on and claims priority from Japanese Patent Application No. 2023-199407 filed on Nov. 24, 2023. The entire contents of these applications are incorporated by reference into the present application.

### BACKGROUND

### 1. Technical Field

The technology of the present disclosure relates to stators.

### 2. Description of Related Art

Conventionally, stators have been known which include a stator core having a plurality of tooth parts extending in a radial fashion, insulators formed of resin and mounted to the stator core, and coil winding parts wound on the respective tooth parts via the respective insulators. Moreover, the known stators include those in which insulating films are provided between the tooth parts and the coil winding parts (see, for example, Japanese Patent Application Publication No. JP 2018-198515 A).

### SUMMARY

As a result of a detailed investigation by the inventors of the present application, the following problem has been found. That is, with the aforementioned prior art, when a high voltage is applied to the coil winding parts, a puncture may occur in the insulating films. It is conceivable to increase the thicknesses of resin parts of the insulators which are provided between the tooth parts and the coil winding parts so as to withstand the high voltage. However, in this case, the size of the stator may increase with the increase in the thicknesses of the resin parts of the insulators.

The technology of the present disclosure has been accomplished in view of the above problem.

A stator according to the technology of the present disclosure includes: a stator core having a plurality of tooth parts extending in a radial fashion; insulators formed of resin and mounted to the stator core; and coil winding parts each of which is wound on a corresponding one of the tooth parts of the stator core via a corresponding one of the insulators. Moreover, the stator core has mounting surfaces on each of which a corresponding one of the insulators is mounted. In each of the mounting surfaces, there is formed a groove that is located on an opposite side of the corresponding insulator to the corresponding coil winding part. A gas layer is formed between the stator core and the corresponding insulator by the groove.

With the technology of the present disclosure, it becomes possible to provide the stator capable of securing insulation of the stator core from the coil winding parts while enabling suppression of increase in the size of the stator.

### BRIEF DESCRIPTION OF THE DRAWINGS

FIG. 1 is a plan view of a stator according to a first embodiment.

FIG. 2 is a plan cross-sectional view of a stator constituent member according to the first embodiment.

FIG. 3 is a plan cross-sectional view of a stator constituent member according to a second embodiment.

FIG. 4 is a plan cross-sectional view of a stator constituent member according to a third embodiment.

FIG. 5 is a plan cross-sectional view of a stator constituent member according to a fourth embodiment.

FIG. 6 is a plan cross-sectional view of a stator constituent member according to a fifth embodiment.

### DESCRIPTION OF EMBODIMENTS

### First Embodiment

First, a first embodiment of the technology of the present disclosure will be described.

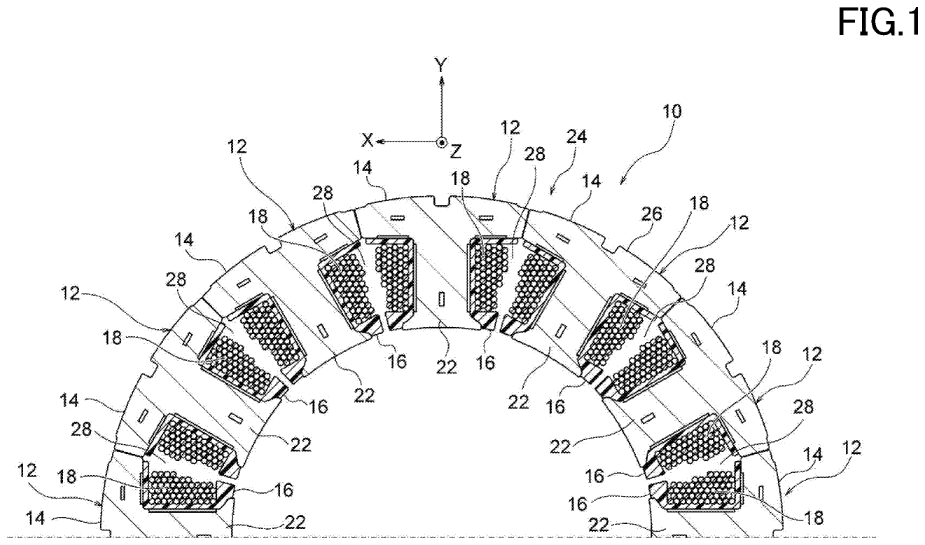

As shown in FIG. 1, a stator 10 according to the first embodiment is constituted of a plurality of stator constituent members 12. The stator 10 is formed by assembling the stator constituent members 12 into an annular shape. FIG. 1 shows the configuration of half of the stator 10. The stator 10 is applied to a brushless motor. Brushless motors may be used in any application. Examples of brushless motors include fan motors, pump drive motors and compressor motors.

It should be noted that in each figure, the X direction represents a tangential direction of the stator 10; the Y direction represents a radial direction of the stator 10; and the Z direction represents an axial direction of the stator 10. Moreover, in the following explanation, the circumferential direction of the stator 10 denotes the direction around a central axis of the stator 10. It also should be noted that the tangential, radial, axial and circumferential directions of a stator core 24 that will be described later are respectively the same as the tangential, radial, axial and circumferential directions of the stator 10.

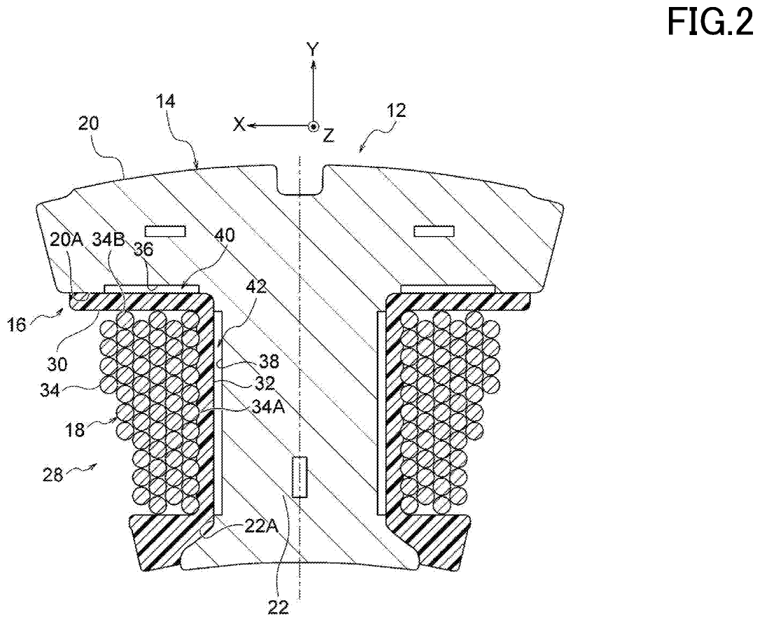

As shown in FIG. 2, each stator constituent member 12 includes a core member 14, an insulator 16 and a coil winding part 18. The core member 14 has a core back part 20 and a tooth part 22. The core back part 20 extends in the circumferential direction of the stator core 24; and the tooth part 22 extends, from a central portion of the core back part 20, inward in the Y direction. In addition, a distal end of the tooth part 22 is a free end; and a proximal end of the tooth part 22 is connected with the core back part 20.

The stator core 24 (see FIG. 1) is formed by assembling the core members 14 into an annular shape. In the state of the stator core 24 having been formed, the core back parts 20 of the core members 14 together form an annular part 26 (see FIG. 1) of the stator core 24; and the tooth parts 22 of the core members 14 extend in a radial fashion around the central axis of the stator core 24. Between the tooth parts 22, there are formed slots 28.

In addition, the configuration of each stator constituent member 12 including its details may not be strictly symmetrical in the X direction when viewed in the Z direction. However, for the sake of convenience, the configuration of only half of each stator constituent member 12 in the X direction will be described hereinafter on the assumption that the main configuration of each stator constituent member 12 is symmetrical in the X direction when viewed in the Z direction.

In each stator constituent member 12, the core back part 20 of the core member 14 has an inner surface 20A; and the tooth part 22 of the core member 14 has a side surface 22A. The inner surface 20A of the core back part 20 extends in both the X and Z directions and faces inward in the Y direction. On the other hand, the side surface 22A of the tooth part 22 extends in both the Y and Z directions and faces in the X direction. Moreover, both the inner surface 20A of the core back part 20 and the side surface 22A of the tooth part 22 adjoin a corresponding one of the slots 28.

The insulator 16 is mounted to the core member 14. The insulator 16 is formed of resin. The resin forming the insulator 16 may be any resin. Examples of the resin forming the insulator 16 include polyimide, polyamide, polyphenylene sulfide (PPS) and polybutylene terephthalate (PBT). The insulator 16 has an inner wall part 30 and a side wall part 32. The inner wall part 30 is mounted on the inner surface 20A of the core back part 20 of the core member 14 so as to cover the inner surface 20A. On the other hand, the side wall part 32 is mounted on the side surface 22A of the tooth part 22 of the core member 14 so as to cover the side surface 22A. Moreover, both the inner wall part 30 and the side wall part 32 are located in a corresponding one of the slots 28.

Each of the inner surface 20A and the side surface 22A is an example of a “mounting surface” according to the technology of the present disclosure. More specifically, the inner surface 20A is an example of a “first mounting surface” according to the technology of the present disclosure; and the side surface 22A is an example of a “second mounting surface” according to the technology of the present disclosure.

The coil winding part 18 is wound on the tooth part 22 of the core member 14 via the insulator 16. The coil winding part 18 is formed by winding a coil with respect to the tooth part 22 around the Y direction. The coil that forms the coil winding part 18 may have only one coil winding part 18 wound on one tooth part 22, or have a plurality of coil winding parts 18 wound respectively on a plurality of tooth parts 22.

The coil winding part 18 has an axial portion 34 that extends in the Z direction. The axial portion 34 is inserted in a corresponding one of the slots 28. The axial portion 34 has a side surface 34A and an end surface 34B. The side surface 34A is a surface (i.e., an inner side surface) of the axial portion 34 which is formed on the tooth part 22 side. On the other hand, the end surface 34B is a surface of the axial portion 34 which is formed on the core back part 20 side. The side wall part 32 of the insulator 16 is interposed between the side surface 34A of the axial portion 34 of the coil winding part 18 and the side surface 22A of the tooth part 22 of the core member 14; and the inner wall part 30 of the insulator 16 is interposed between the end surface 34B of the axial portion 34 of the coil winding part 18 and the inner surface 20A of the core back part 20 of the core member 14.

A first groove 36 is formed in the inner surface 20A of the core back part 20 of the core member 14; and a second groove 38 is formed in the side surface 22A of the tooth part 22 of the core member 14. The first groove 36 is located on an opposite side of the inner wall part 30 of the insulator 16 to the coil winding part 18 in the Y direction; and the second groove 38 is located on an opposite side of the side wall part 32 of the insulator 16 to the coil winding part 18 in the X direction. The position and width of the first groove 36 in the X direction are set so that the range of the width of the coil winding part 18 in the X direction is included within the range of the width of the first groove 36 in the X direction. Similarly, the position and width of the second groove 38 in the Y direction are set so that the range of the width of the coil winding part 18 in the Y direction is included within the range of the width of the second groove 38 in the Y direction.

A first gas layer 40 is formed between the core back part 20 of the core member 14 and the inner wall part 30 of the insulator 16 by the first groove 36; and a second gas layer 42 is formed between the tooth part 22 of the core member 14 and the side wall part 32 of the insulator 16 by the second groove 38. In addition, both the first groove 36 and the second groove 38 are formed so as to penetrate the core member 14 in the Z direction.

Each of the first groove 36 and the second groove 38 is an example of a “groove” according to the technology of the present disclosure. Moreover, each of the first gas layer 40 and the second gas layer 42 is an example of a “gas layer” according to the technology of the present disclosure.

Next, the operation and effects of the stator 10 according to the first embodiment of the technology of the present disclosure will be described.

As described in detail above, in the first embodiment, in each stator constituent member 12, the first gas layer 40 is formed between the core back part 20 of the core member 14 and the inner wall part 30 of the insulator 16 by the first groove 36; and the second gas layer 42 is formed between the tooth part 22 of the core member 14 and the side wall part 32 of the insulator 16 by the second groove 38. Consequently, between the core back part 20 of the core member 14 and the coil winding part 18, there is formed an insulating layer that includes the first gas layer 40 in addition to the inner wall part 30 of the insulator 16; thus, it becomes possible to secure insulation of the core back part 20 of the core member 14 from the coil winding part 18. Moreover, between the tooth part 22 of the core member 14 and the coil winding part 18, there is formed an insulating layer that includes the second gas layer 42 in addition to the side wall part 32 of the insulator 16; thus, it becomes possible to secure insulation of the tooth part 22 of the core member 14 from the coil winding part 18.

Furthermore, with the first gas layer 40 formed between the core back part 20 of the core member 14 and the inner wall part 30 of the insulator 16 by the first groove 36, it becomes possible to reduce the thickness of the inner wall part 30 of the insulator 16 as compared with the case of securing insulation of the core back part 20 of the core member 14 from the coil winding part 18 only by the inner wall part 30 of the insulator 16. Similarly, with the second gas layer 42 formed between the tooth part 22 of the core member 14 and the side wall part 32 of the insulator 16 by the second groove 38, it becomes possible to reduce the thickness of the side wall part 32 of the insulator 16 as compared with the case of securing insulation of the tooth part 22 of the core member 14 from the coil winding part 18 only by the side wall part 32 of the insulator 16. Consequently, it becomes possible to increase the cross-sectional area of each slot 28 and thus the number of turns of each coil winding part 18. As a result, it becomes possible to suppress increase in the size of the stator 10. That is, it becomes possible to suppress the size of the stator 10 from being increased for increasing the cross-sectional area of each slot 28.

### Second Embodiment

Next, a second embodiment of the technology of the present disclosure will be described.

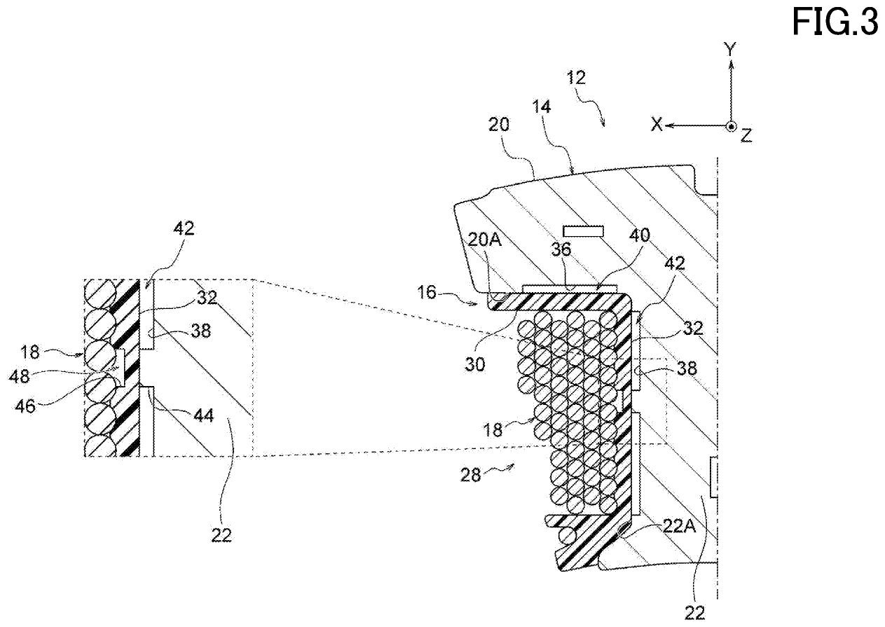

In the second embodiment, the configuration of the stator 10 is modified as follows compared to the first embodiment. That is, as shown in FIG. 3, on a bottom surface of the second groove 38, there is formed a protrusion 44 that protrudes toward the side wall part 32 of the insulator 16. The protrusion 44 is in contact with the side wall part 32 of the insulator 16 and supports the side wall part 32. On the other hand, a recess 46 is formed in a surface of the side wall part 32 of the insulator 16 on the opposite side to a contact surface of the side wall part 32 which is in contact with the protrusion 44; and a gas layer 48 is formed between the coil winding part 18 and the side wall part 32 of the insulator 16 by the recess 46. The recess 46 is formed at the same position as the protrusion 44 in the Y direction. In addition, the recess 46 is formed so as to penetrate the side wall part 32 of the insulator 16 in the Z direction.

With the above configuration, since the side wall part 32 of the insulator 16 is supported by the protrusion 44, the rigidity of the side wall part 32 can be improved. Moreover, although there is the protrusion 44 formed on the bottom surface of the second groove 38, with the gas layer 48 formed by the recess 46, it is still possible to secure insulation of the tooth part 22 of the core member 14 from the coil winding part 18.

In the example shown in FIG. 3, a single protrusion 44 is formed on the bottom surface of the second groove 38. Alternatively, a plurality of protrusions 44 may be formed on the bottom surface of the second groove 38. Further, corresponding to the plurality of protrusions 44, a plurality of recesses 46 may be formed in the surface of the side wall part 32 of the insulator 16 on the opposite side to the contact surface of the side wall part 32 which is in contact with the protrusion 44.

Moreover, in the example shown in FIG. 3, a protrusion 44 may be formed on a bottom surface of the first groove 36 to protrude toward the inner wall part 30 of the insulator 16 and support the inner wall part 30. Further, a recess 46 may be formed in a surface of the inner wall part 30 of the insulator 16 on the opposite side to a contact surface of the inner wall part 30 which is in contact with the protrusion 44; and a gas layer 48 may be formed between the coil winding part 18 and the inner wall part 30 of the insulator 16 by the recess 46.

With the above configuration, since the inner wall part 30 of the insulator 16 is supported by the protrusion 44, the rigidity of the inner wall part 30 can be improved. Moreover, although there is the protrusion 44 formed on the bottom surface of the first groove 36, with the gas layer 48 formed by the recess 46, it is still possible to secure insulation of the core back part 20 of the core member 14 from the coil winding part 18.

### Third Embodiment

Next, a third embodiment of the technology of the present disclosure will be described.

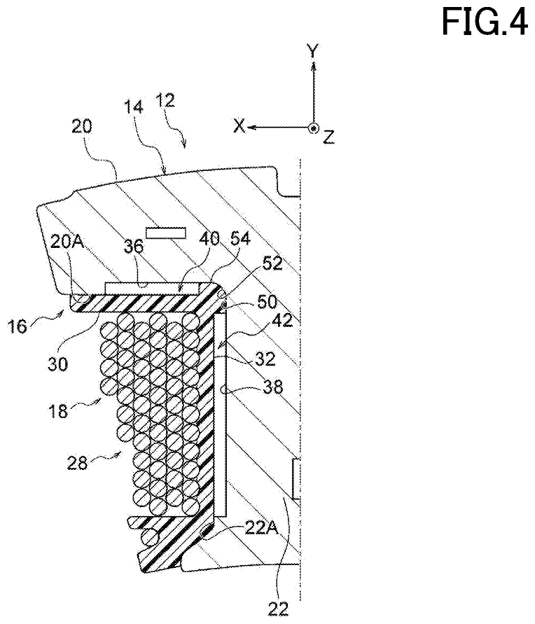

In the third embodiment, the configuration of the stator 10 is modified as follows compared to the first embodiment. That is, as shown in FIG. 4, in the core member 14, there is formed a groove 50 that extends continuously from the inner surface 20A of the core back part 20 to the side surface 22A of the tooth part 22. The insulator 16 has a partition part 54 that is located at a rounded part 52 which is a connection part between the inner surface 20A of the core back part 20 and the side surface 22A of the tooth part 22. The partition part 54 partitions the groove 50 into a first groove 36 and a second groove 38.

With the above configuration, the groove 50 can be formed continuously from the inner surface 20A of the core back part 20 to the side surface 22A of the tooth part 22; thus, a process for forming the groove 50 can be easily performed.

Moreover, the insulator 16 has the partition part 54 located at the rounded part 52 which is the connection part between the inner surface 20A of the core back part 20 and the side surface 22A of the tooth part 22; therefore, both the inner wall part 30 and the side wall part 32 of the insulator 16 can be supported by the partition part 54. Consequently, although there is the groove 50 formed continuously from the inner surface 20A of the core back part 20 to the side surface 22A of the tooth part 22, it is still possible to secure the rigidity of both the inner wall part 30 and the side wall part 32 of the insulator 16.

### Fourth Embodiment

Next, a fourth embodiment of the technology of the present disclosure will be described.

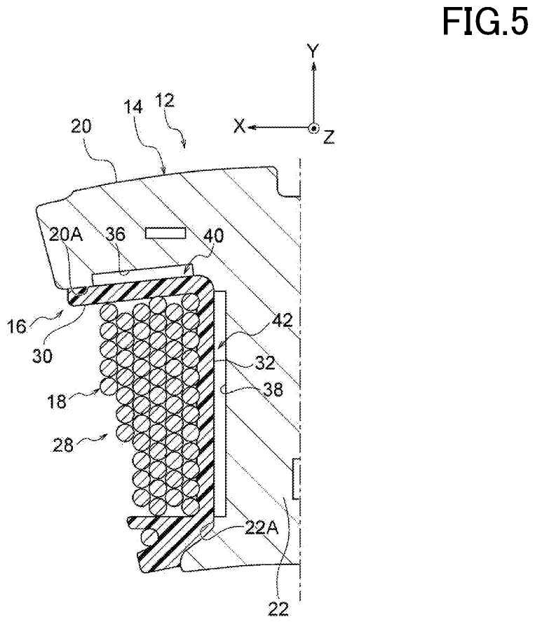

In the fourth embodiment, the configuration of the stator 10 is modified as follows compared to the first embodiment. That is, in the first embodiment, the inner surface 20A of the core back part 20 extends in the X direction when viewed in the Z direction. In contrast, in the fourth embodiment, as shown in FIG. 5, the inner surface 20A of the core back part 20 extends in a direction that is inclined from the X direction inward in the Y direction when viewed in the Z direction. The fourth embodiment is the same as the first embodiment in that: the first gas layer 40 is formed between the core back part 20 of the core member 14 and the inner wall part 30 of the insulator 16 by the first groove 36; and the second gas layer 42 is formed between the tooth part 22 of the core member 14 and the side wall part 32 of the insulator 16 by the second groove 38.

With the above configuration, it is also possible to achieve the same advantageous effects as achievable according to the first embodiment.

### Fifth Embodiment

Next, a fifth embodiment of the technology of the present disclosure will be described.

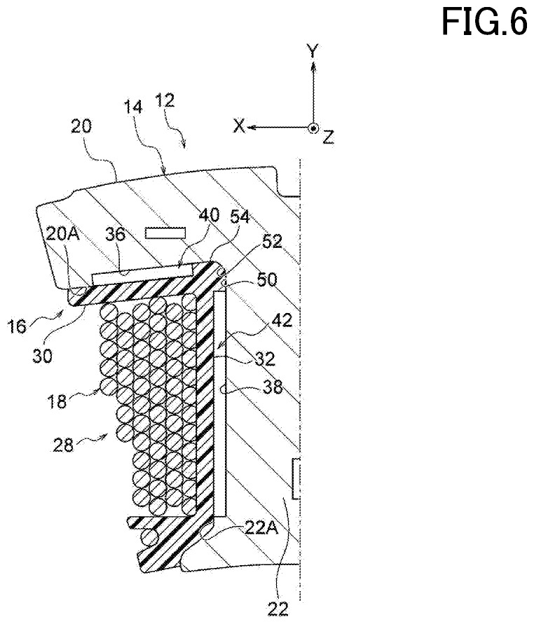

In the fifth embodiment, the configuration of the stator 10 is modified as follows compared to the third embodiment. That is, in the third embodiment, the inner surface 20A of the core back part 20 extends in the X direction when viewed in the Z direction. In contrast, in the fifth embodiment, as shown in FIG. 6, the inner surface 20A of the core back part 20 extends in a direction that is inclined from the X direction inward in the Y direction when viewed in the Z direction. The fifth embodiment is the same as the third embodiment in that: the core member 14 has formed therein the groove 50 that extends continuously from the inner surface 20A of the core back part 20 to the side surface 22A of the tooth part 22; and the insulator 16 has the partition part 54 located at the rounded part 52 which is the connection part between the inner surface 20A of the core back part 20 and the side surface 22A of the tooth part 22.

With the above configuration, it is also possible to achieve the same advantageous effects as achievable according to the third embodiment.

In the above-described embodiments, the stator core 24 is segmented into the plurality of core members 14. Alternatively, the plurality of core members 14 may be integrally formed into one piece. In addition, the insulators 16 mounted respectively to the core members 14 may also be integrally formed into one piece.

Moreover, of the configurations of the stator 10 described in the above embodiments, those configurations which can be combined with each other may be combined as appropriate.

While the technology of the present disclosure has been described pursuant to the above-described embodiments, it should be appreciated that the technology of the present disclosure is not limited to the above-described embodiments, but can also be implemented through various modifications to the above-described embodiments without departing from the gist of the technology of the present disclosure.

The following notes summarize the technology of the present disclosure.

### First Note

A stator (10) comprising:
a stator core (24) having a plurality of tooth parts (22) extending in a radial fashion;
insulators (16) formed of resin and mounted to the stator core; and
coil winding parts (18) each of which is wound on a corresponding one of the tooth parts of the stator core via a corresponding one of the insulators,
wherein:
the stator core has mounting surfaces (20A, 22A) on each of which a corresponding one of the insulators is mounted;
in each of the mounting surfaces, there is formed a groove (36, 38, 50) that is located on an opposite side of the corresponding insulator to the corresponding coil winding part; and
a gas layer (40, 42) is formed between the stator core and the corresponding insulator by the groove.

### Second Note

The stator according to the first note, wherein:
the stator core further has core back parts (20) each of which extends in a circumferential direction of the stator core and is connected with a proximal end of a corresponding one of the tooth parts;
each of the mounting surfaces comprises a first mounting surface (20A) formed in a corresponding one of the core back parts, and a second mounting surface (22A) formed in a corresponding one of the tooth parts; and
the groove (36, 38) comprises a first groove (36) formed in the first mounting surface, and a second groove (38) formed in the second mounting surface.

### Third Note

The stator according to the second note, wherein:
the groove (50) extends continuously from the first mounting surface to the second mounting surface; and
the one of the insulators which corresponds to the groove has a partition part (54) that is located at a connection part (52) of the stator core between the first mounting surface and the second mounting surface and partitions the groove into the first groove and the second groove.

### Fourth Note

The stator according to any one of the first to third notes, wherein:
on a bottom surface of the groove, there is formed a protrusion (44) that protrudes toward the corresponding insulator and supports the corresponding insulator; and
in a surface of the corresponding insulator on an opposite side to a contact surface of the corresponding insulator which is in contact with the protrusion, there is formed a recess (46) by which a gas layer (48) is formed between the corresponding coil winding part and the corresponding insulator.

What is claimed is:

1. A stator comprising:
a stator core having a plurality of tooth parts extending in a radial fashion;
insulators formed of resin and mounted to the stator core; and
coil winding parts each of which is wound on a corresponding one of the tooth parts of the stator core via a corresponding one of the insulators,
wherein:
the stator core has mounting surfaces on each of which a corresponding one of the insulators is mounted;
in each of the mounting surfaces, there is formed a groove that is located on an opposite side of the corresponding insulator to the corresponding coil winding part; and
a gas layer is formed between the stator core and the corresponding insulator by the groove.

2. The stator as set forth in claim 1, wherein:
the stator core further has core back parts each of which extends in a circumferential direction of the stator core and is connected with a proximal end of a corresponding one of the tooth parts;
each of the mounting surfaces comprises a first mounting surface formed in a corresponding one of the core back parts, and a second mounting surface formed in a corresponding one of the tooth parts; and
the groove comprises a first groove formed in the first mounting surface, and a second groove formed in the second mounting surface.

3. The stator as set forth in claim 2, wherein:
the groove extends continuously from the first mounting surface to the second mounting surface; and
the one of the insulators which corresponds to the groove has a partition part that is located at a connection part of the stator core between the first mounting surface and the second mounting surface and partitions the groove into the first groove and the second groove.

4. The stator as set forth in claim 1, wherein:
on a bottom surface of the groove, there is formed a protrusion that protrudes toward the corresponding insulator and supports the corresponding insulator; and
in a surface of the corresponding insulator on an opposite side to a contact surface of the corresponding insulator which is in contact with the protrusion, there is formed a recess by which a gas layer is formed between the corresponding coil winding part and the corresponding insulator.
